(19) United States
(12) Patent Application Publication
(10) Pub. No.: US 2016/0171474 A1
(43) Pub. Date: Jun. 16, 2016

(54) System, Method and Device for Performing a Transaction

(71) Applicant: OK Top B.V., Amstelveen (NL)

(72) Inventor: Michiel Laurens Jakob Liezenberg, Aerdenhout (NL)

(21) Appl. No.: 15/049,480

(22) Filed: Feb. 22, 2016

Related U.S. Application Data
(63) Continuation of application No. 14/164,931, filed on Jan. 27, 2014.

(51) Int. Cl. G06Q 20/32; G06F 3/0488; G06F 3/0484; H04M 1/725

(52) U.S. Cl. CPC G06Q 20/3223; H04M 1/7253; G06F 3/0488; G06F 3/0484

(57) ABSTRACT

The present invention relates to a system, method and mobile device for performing a transaction, comprising data input means, such as a touch screen; data displaying means, such as said touch screen; data communication means, such as any internet protocol communication means; data processing means, for executing software applications, loaded with at least: an application for: performing a sequence of interactions via the internet with a first external party, offering a good and/or service for sale; and a second external party, offering a payment service; and displaying on the data displaying means a background image in dependence of the external party instantaneous interaction takes place with.

### CROSS REFERENCE TO RELATED APPLICATIONS

This application claims the benefit of U.S. patent application Ser. No. 14/164,931, filed Jan. 27, 2014, which is hereby incorporated in its entirety by reference.

### BACKGROUND OF THE INVENTION

1. Field of the Invention

The present invention relates to a system, method and device for performing a transaction, in particular the invention relates to a system, method and device for electronically performing such transaction. A transaction here indicates in particular an authorization transaction, or logging in or creating an account or voting.

2. Description of Related Art

In recent years, electronic transactions have become common. E-commerce, and in particular online shopping are growing markets, and also the use of mobile devices, in particular mobile phones, has gained popularity. This is effectively blurring the boundaries of e-commerce and traditional commerce channels as the mobile phone can also be used to perform transactions in traditional channels.

Shops offer goods and services, and multiple parties offer payment methods, across all different sales channels. For all of which typically a user needs an account with both shop and payment method. Besides regular payments with debit or credit cards, dedicated online payment methods like iDeal and PayPal exist. Furthermore, banks offer applications for online and mobile banking, with which payment transfers can be performed.

Although the existing transaction applications fulfill a certain need, the need for using multiple separate applications is considered cumbersome, and their mutual interoperability is often low. In addition, when a user performs an electronic transaction, the applications, in particular on devices with a relatively small display area, like mobile devices, often make it unclear with what party a user is actually performing what step, with the result that credentials may be supplied to the wrong party, at the wrong time.

At the same time, mobile phones have developed with a wide range of mobile phone applications. The mobile phones, in particular mobile ‘smart phones’, offer a lot of personalization options, including setting background images or ‘wallpapers’.

In the prior art, said wallpapers are set for the phone or for a mobile phone application only by the user and only using images that are available on the phone. Said set wallpapers remain active until reconfigured by the user.

Although the existing options fulfill a need of the user or the issuer of the phone or mobile phone application, a need for making the background images, in particular the background images in mobile phone applications, more dynamic and context specific exists with external parties with which the mobile phone or mobile phone application may interact, in particular when performing transactions, to visually reflect and re-iterate the relationship between the user and the external party the instantaneous interaction takes place with during said interaction.

It is a goal of the present invention to take away the above disadvantages, or at least to provide a useful alternative to the prior art.

### SUMMARY OF THE INVENTION

The invention thereto proposes a device for performing a transaction, comprising data input means, such as a touch screen; data displaying means, such as said touch screen; data communication means, such as any internet protocol communication means; data processing means, for executing software applications, loaded with at least: an application for performing interaction via the internet with a first external party, offering a good and/or service for sale; and a second external party, offering a payment service; and displaying on the data displaying means a background image in dependence of the external party instantaneous interaction takes place with.

The device may for instance be a smart phone or tablet, and the term performing interaction may for instance comprise exchanging transaction or purchase data. With a background is meant here what is also called a wallpaper in case of a desktop or home screen: a picture that essentially fills the entire surface of a screen, with functional elements on top of it.

The application facilitates the entire transaction. Said transaction in case of a virtual checkout process with a seller, comprising the interactions of initiating the transaction, selection of a payment service showing a wallpaper of the payment service, authorization of the payment to the seller showing a wallpaper of the seller, and confirmation of the payment and purchase showing a wallpaper of the seller.

In order to keep the look and feel, branding or advertisement strategy of these companies towards the user up to date, the application may in an embodiment be configured to retrieve an actual background image from the external party actual interaction takes place with. Various algorithms can be implemented for this purpose. The picture can be refreshed when using the application, or the last one used can be stored on the device, and be updated when a newer one is available and the data connection is considered fast enough to download data. In a preferred embodiment, the application is configured for performing a check at the moment of interaction with a party, for an updated image.

The application may in yet another embodiment be configured for performing interaction via the internet with a third external party, offering a coupon or the like. In such case, when using the coupon, a corresponding background image is displayed indicating to the user that the present interaction takes place with the coupon issuing party.

The application may in a further embodiment be configured for performing any of the following actions: account creation, login, data validation and/or voting.

Or said transaction in case of an account creation, login, data validation or voting process, comprising the interactions of initiating the transaction, authorization of the account creation, login, data validation or vote with a service showing a wallpaper of the service, and confirmation of the account creation, login, data validation or vote showing a wallpaper of the service. Or said transaction in case of a issuing process for a coupon, ticket or the like, comprising the interactions of initiating the transaction, authorization of issuing the coupon, ticket, loyalty card or the like from an issuer showing a wallpaper of the issuer, and confirmation of the issuance of the coupon, ticket or the like showing a wallpaper of the issuer.

Preferably the application is designed such that the wallpaper takes up the largest part of the of the surface of the data displaying means, if not the entire surface, and a minimum of interactive controls, data elements and/or data fields to facilitate said interaction are visually superimposed on the wallpaper.

The application further relates to a method for performing a transaction, comprising performing interaction via the internet with a first external party, offering a good and/or service for sale; and a second external party, offering a payment service; and displaying on data displaying means a background image in dependence of the external party instantaneous interaction takes place with. Here also in an embodiment, the method comprises the step of retrieving an actual background image from the party actual the interaction takes place with and/or performing a check at the moment of interaction with a party, for an updated image.

A system according to the present invention comprises a smart device as described above, as well as a first external party, offering a good and/or service for sale; and a second external party, offering a payment service.

### BRIEF DESCRIPTION OF THE DRAWING(S)

The invention will now be elucidated into more detail referring to the following figures, wherein:

FIG. 1 shows a screenshot of an application according to the state of the art;

FIG. 2 shows a screenshot of an application according to the present invention;

FIG. 3 shows a screenshot of an application according to the present invention;

FIG. 4 shows a screenshot of an application according to the present invention;

FIG. 5 shows a screenshot of an application according to the present invention;

FIG. 6 shows a screenshot of an application according to the present invention;

FIG. 7 shows a screenshot of an application according to the present invention;

FIG. 8 shows a screenshot of an application according to the present invention; and

FIG. 9 shows a screenshot of an application according to the present invention.

### DESCRIPTION OF THE INVENTION

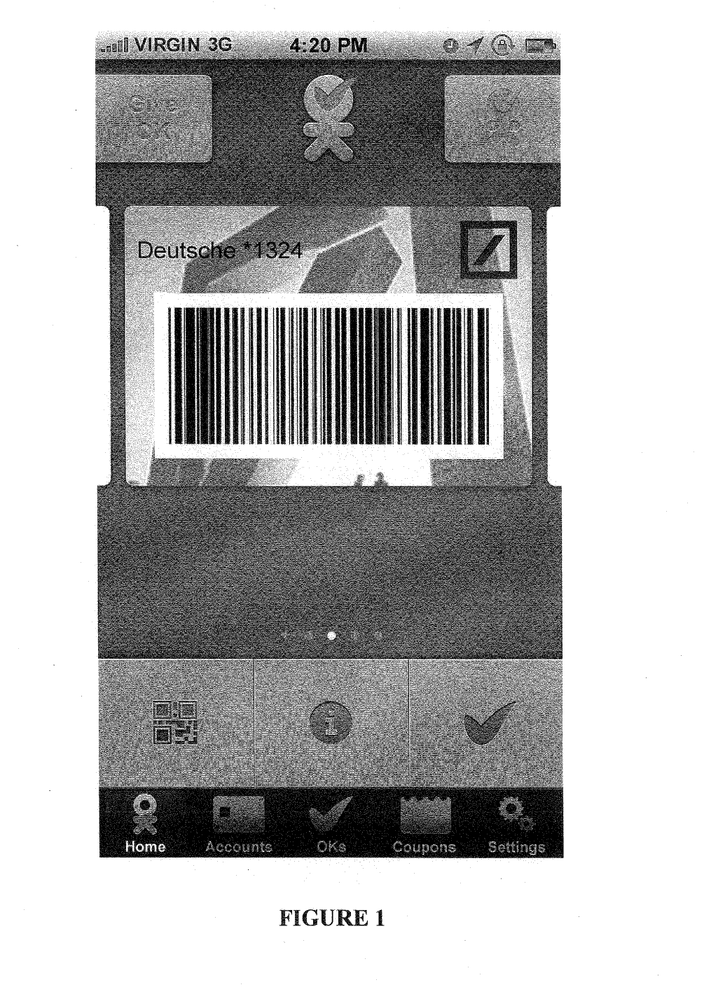

FIG. 1 shows a screenshot of an application according to the state of the art; Visible is a picture of a mimicked bank or credit card from Deutsche Bank that only stretches to a part of the available area. A user has the impression that the actual application is in the background and indicated with the dotted grey area, leaving a lot of screen area unused, and missing an opportunity to satisfy the need of the party the actual interaction takes place with.

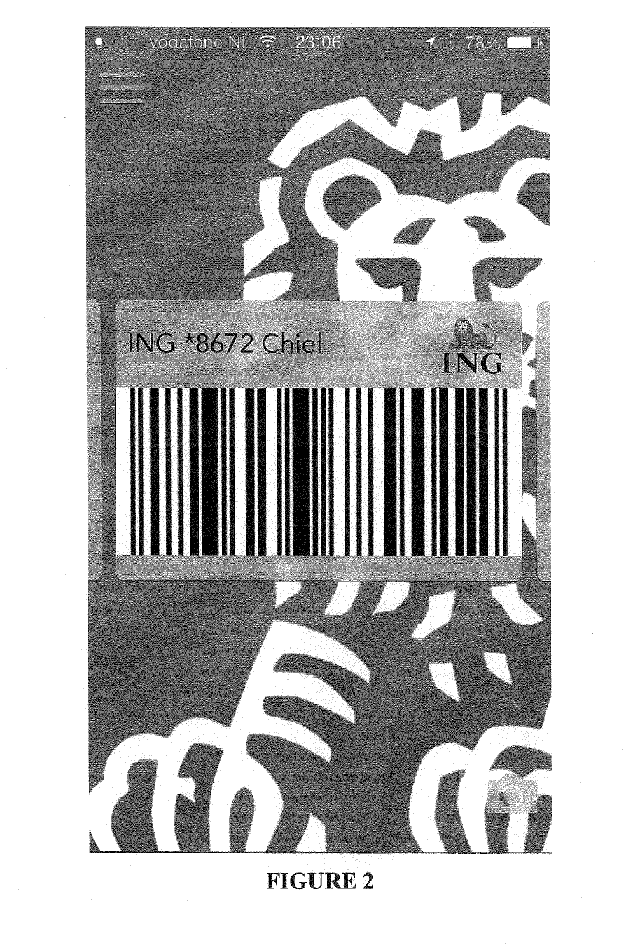

FIG. 2 shows a screenshot of an application according to the present invention. Here, a full screen image of the logo of the ING bank is depicted in the application, making it clear that the user is currently interacting with ING.

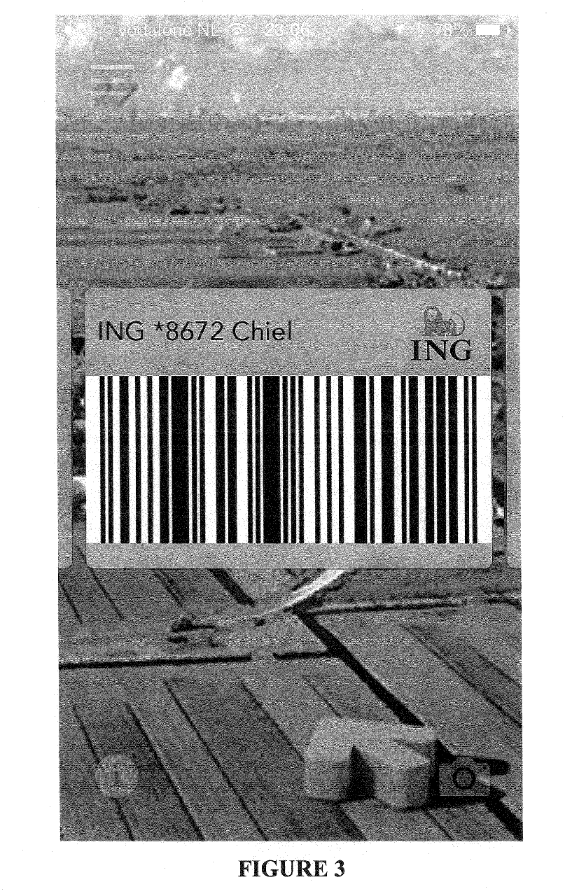

FIG. 3 shows a screenshot of the exact same step in the application where ING has meanwhile updated the background image to be aligned with their running advertisement campaign.

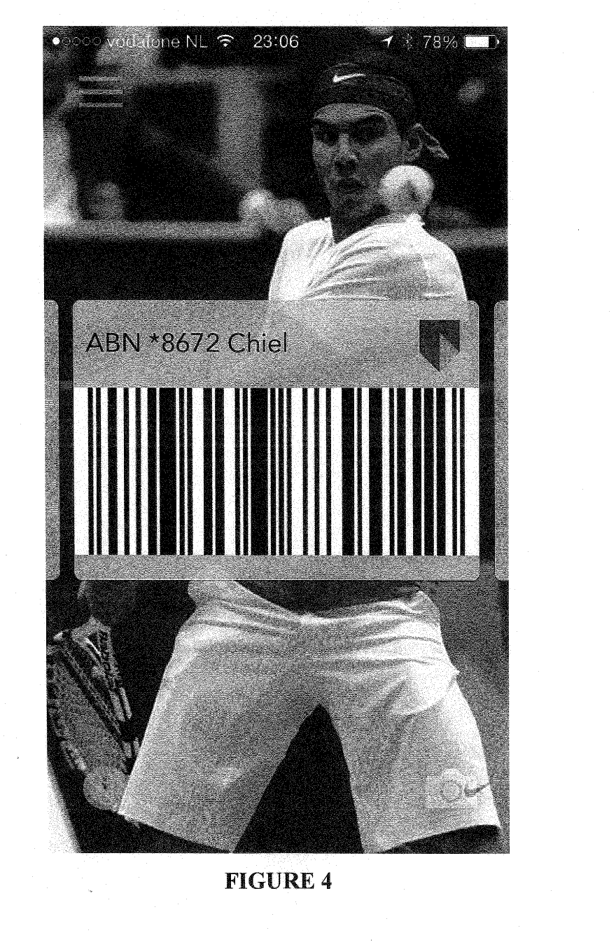

FIG. 4 shows screenshot similar to the one from FIG. 2, but here with a full screen picture of wallpaper of ABN Amro bank, with a tennis player in front of an ABN Amro banner.

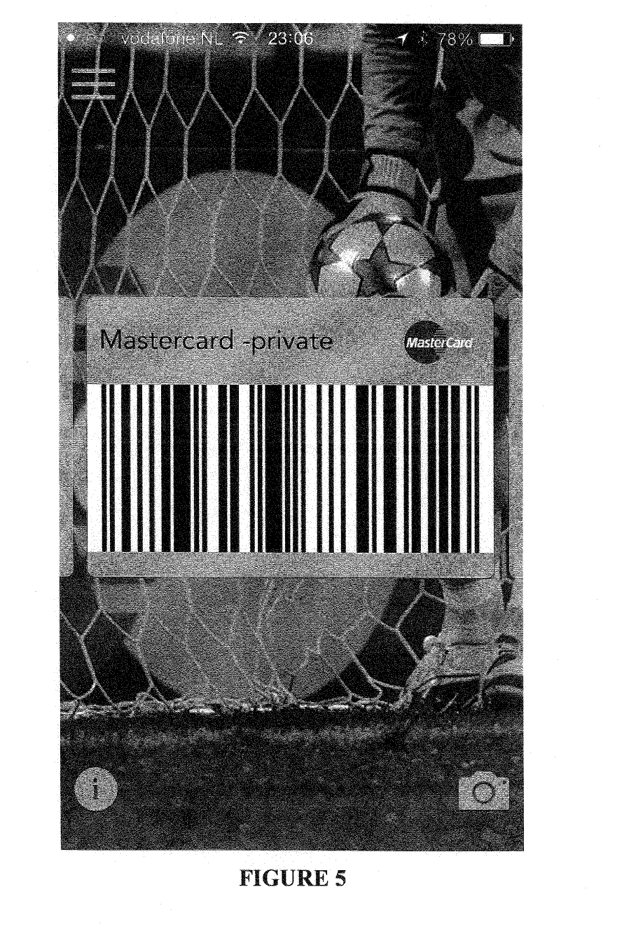

FIG. 5 shows a similar screenshot to that of FIG. 4, but now for Mastercard.

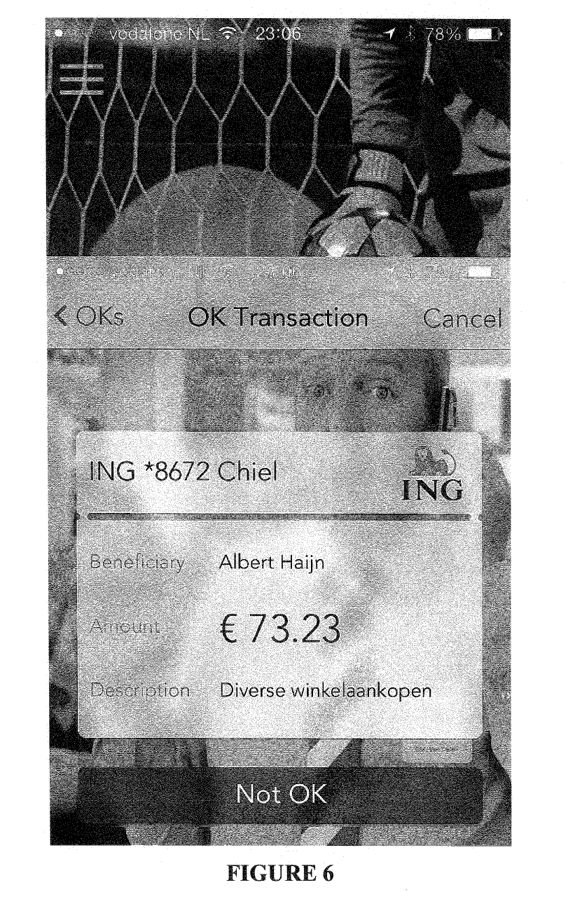

FIG. 6 shows a screenshot of a transaction according to the present invention. Visible is a background belonging to the first external party, in this case Albert Heijn, with a proposed payment amount. The user has in an earlier step selected to perform the payment to Albert Heijn with his ING payment account, therefore the logo of ING is depicted on top of the payment details.

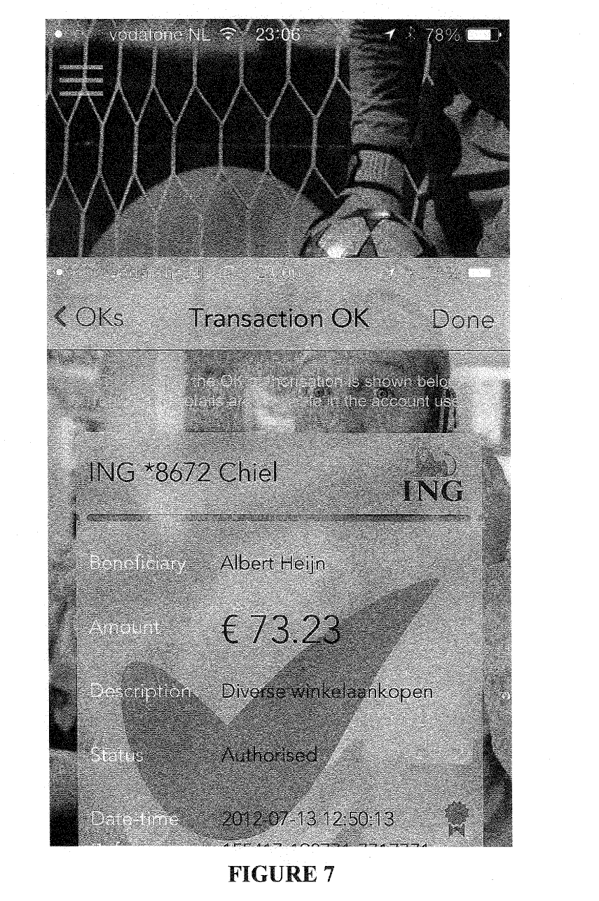

FIG. 7 shows a screenshot of the application of FIG. 6, after the user has authorized the payment.

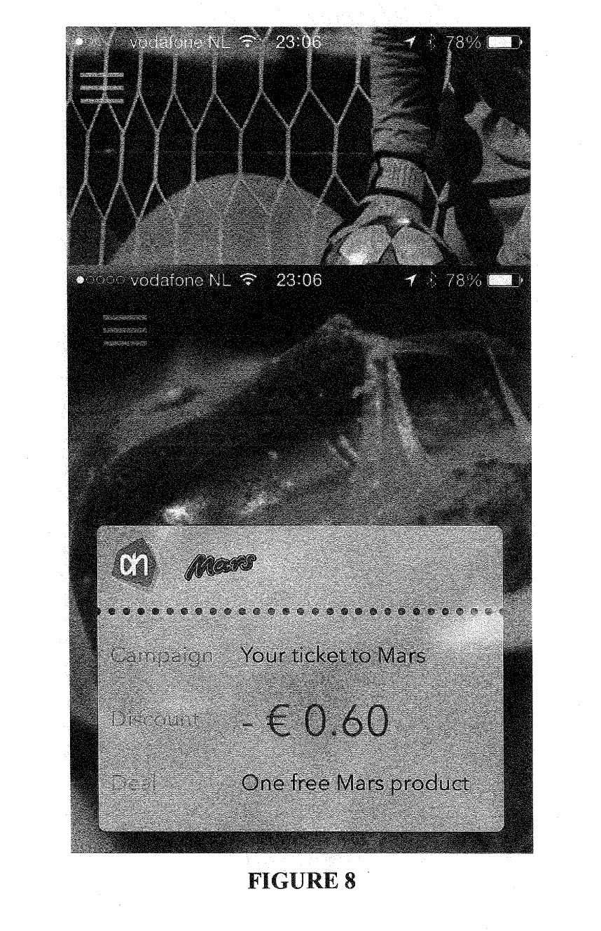

FIG. 8 shows a screenshot of a discount coupon, issued by a third party, for instance Mars, to obtain a discount when purchasing an item at Albert Heijn.

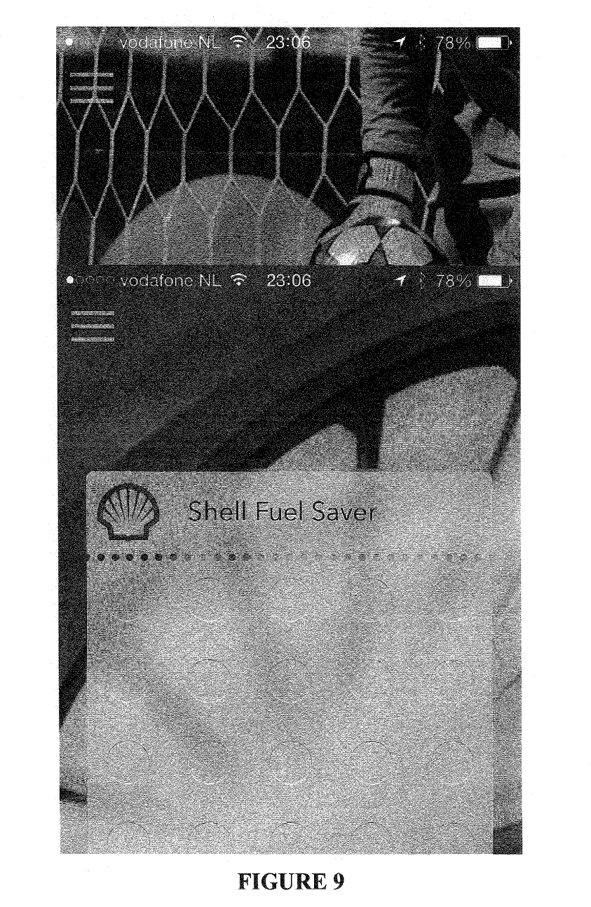

FIG. 9 shows a screenshot of a loyalty card issued by Shell.

1. A mobile device for automatically configuring a background display, the mobile device comprising:
a display configured to display a user interface, the user interface comprising a background display and functional elements displayed on top of the background display;
communication circuitry configured to communicate with an external computer system; and
a processor configured to determine the background display based on the external computer system and automatically control the display to display the background display during communication with the external computer system.

2. The mobile device of claim 1, wherein the processor is configured to determine the background display based on an image stored in a memory of the mobile device.

3. The mobile device of claim 1, wherein the processor is configured to determine the background display based on an image received from the external computer system.

4. The mobile device of claim 1, wherein the processor is configured to determine the background display based on data communicated during the communication with the external computer system.

5. The mobile device of claim 1, wherein the communication circuitry is configured to communicate with the external computer system by performing at least one transaction.

6. The mobile device of claim 5, wherein the background display comprises information on the at least one transaction.

7. The mobile device of claim 6, wherein the information comprises an amount of a payment to or from the external computer system.

8. The mobile device of claim 5, wherein the processor is configured to determine the background display based on an image received from the external computer system during the communication with the external computer system for the at least one transaction.

9. The mobile device of claim 5, wherein the at least one transaction includes at least one of the following: purchasing a good and/or service for sale from the external computer system, making a payment to or from the external computer system, creating an account with the external computer system, logging into the account with the external computer system; validating data with the external computer system, voting with the external computer system, and using a coupon with the external computer system.

10. The mobile device of claim 1, wherein the communication circuitry is configured to communicate with another external computer system, and wherein the processor is configured to determine another background display based on the another external computer system and automatically control the display to display the another background display during communication with the another external computer system.

11. The mobile device of claim 10, wherein the communication circuitry is configured to perform communications with the external computer system for purchasing a good and/or service for sale from the external computer system, and wherein the communication circuitry is configured to perform communications with the another external computer system for making a payment to the external computer system from the another external computer system.

12. The mobile device of claim 1, wherein the background display substantially fills the entire display with the functional elements displayed on top of the background display.

13. The mobile device of claim 1, wherein the background display comprises a wallpaper of the user interface of the mobile device.

14. A method for automatically configuring a background display of a mobile device, the method comprising:
communicating, by communication circuitry in the mobile device, with an external computer system;
determining, by a processor in the mobile device, a background display based on the external computer system; and
automatically controlling, by the processer, a display of the mobile device to display the background display as part of a user interface including the background display and functional elements displayed on top of the background display.

15. The method of claim 14, further comprising:
determining, by the processor, the background display based on an image stored in a memory of the mobile device.

16. The method of claim 14, further comprising:
determining, by the processor, the background display based on an image received from the external computer system.

17. The method of claim 14, further comprising:
determining, by the processor, the background display based on data communicated during the communication with the external computer system.

18. The method of claim 14, wherein the communicating with the external computer system comprises performing at least one transaction with the external computer system.

19. The method of claim 18, wherein the background display comprises information on the at least one transaction.

20. The method of claim 19, wherein the information comprises an amount of a payment to or from the external computer system.

21. The mobile device of claim 18, further comprising:
determining, by the processor, the background display based on an image received from the external computer system during communications with the external computer system for the at least one transaction.

22. The method of claim 18, wherein the at least one transaction includes at least one of the following: purchasing a good and/or service for sale from the external computer system, making a payment to or from the external computer system, creating an account with the external computer system, logging into the account with the external computer system; validating data with the external computer system, voting with the external computer system, and using a coupon with the external computer system.

23. The method of claim 14, further comprising:
communicating, by the communication circuitry, with another external computer system; and
determining, by the processor, another background display based on the another external computer system; and
automatically controlling, by the processor, the display to display the another background display during communication with the another external computer system.

24. The method of claim 23, further comprising:
performing, by the communication circuitry, communications with the external computer system for purchasing a good and/or service for sale from the external computer system; and
performing, by the communication circuitry, communications with the another external computer system for making a payment to the external computer system from the another external computer system.

25. The method of claim 14, wherein the background display substantially fills the entire display with the functional elements displayed on top of the background display.

26. The method of claim 14, wherein the background display comprises a wallpaper of the user interface of the mobile device.

27. A non-transitory computer-readable medium configured to store a set of code modules which when executed by a processor of a mobile device become operational for automatically configuring a background display of the mobile device, the computer-readable medium comprising:
code for communicating with an external computer system;
code for determining a background display based on the external computer system; and
code for automatically controlling a display of the mobile device to display the background display as part of a user interface at the mobile device, wherein the user interface comprises the background display and functional elements displayed on top of the background display.
